(19) United States
(12) Patent Application Publication
(10) Pub. No.: US 2017/0013251 A1
(43) Pub. Date: Jan. 12, 2017

(54) THREE-DIMENSIONAL PROJECTION

(71) Applicant: Samuel Arledge Thigpen, San Jose, CA (US)

(72) Inventor: Samuel Arledge Thigpen, San Jose, CA (US)

(21) Appl. No.: 14/797,014

(22) Filed: Jul. 10, 2015

(51) Int. Cl. H04N 13/04; H04N 5/225; H04N 13/02; H04N 9/31; H04N 5/372

(52) U.S. Cl. CPC H04N 13/049; H04N 9/3164; H04N 9/3161; H04N 9/3197; H04N 5/372; H04N 13/02; H04N 5/2253

(57) ABSTRACT

Systems and methods for 3D projection are provided herein. Exemplary systems may include: an air pump receiving air from an air vent and providing the air to a plurality of nozzles; a fluid pump receiving fluid from a fluid reservoir and providing the fluid to the plurality of nozzles; a plurality of light sources providing a light to the plurality of nozzles; and the plurality of nozzles disposed in an evenly-spaced two-dimensional array, each nozzle including: an air sheaf comprising air turbine blades, a fluid sheaf comprising fluid turbine blades, and a plurality of lenses each producing a light beam using light generated by a respective one of the plurality of light sources and moving about a lens track, such that each of the light beams is temporally focused on a same point in the mist column producing a voxel, a plurality of produced voxels comprising a 3D image.

### FIELD OF THE INVENTION

The present technology pertains to projection systems, and more specifically to three-dimensional projection systems.

### BACKGROUND ART

A stereo display or three-dimensional (3D) display is a display device capable of conveying depth perception to the viewer by means of stereopsis for binocular vision. Stereo displays present offset images that are displayed separately to the left and right eye. Stereo display systems rely on special headgear or glasses to provide the offset images. Both of these 2D offset images are then combined in the (human) brain to give the perception of 3D depth. Although the term “3D” is commonly used, the presentation of dual 2D images is different from displaying an image in three full dimensions. For example, moving the observer's head and eyes does not increase information about the 3-dimensional objects being displayed.

Autostereoscopy is a method of displaying stereoscopic images (i.e., adding binocular perception of 3D depth) without the use of special headgear or glasses on the part of the viewer. For example, a parallax barrier is a device placed in front of an image source, such as a liquid crystal display, to allow it to show a stereoscopic image or multiscopic image without the need for the viewer to wear 3D glasses. Such techniques present images on a 2D plane, which is different from displaying an image in three full dimensions.

### SUMMARY OF THE INVENTION

Some embodiments of the present technology include systems for three-dimensional projection. The system may include: an air pump receiving air from an air vent and providing the air to a plurality of nozzles; a fluid pump receiving fluid from a fluid reservoir and providing the fluid to the plurality of nozzles; a plurality of light sources providing a light to the plurality of nozzles; and the plurality of nozzles disposed in an evenly-spaced two-dimensional array, each nozzle including: an air sheaf receiving the pumped air and comprising air turbine blades, a fluid sheaf receiving the pumped fluid and comprising fluid turbine blades, each nozzle atomizing the fluid with the air and projecting the atomized fluid in a mist column using the air sheaf and the fluid sheaf flow pressure and shape, and a plurality of lenses each producing a light beam using light generated by a respective one of the plurality of light sources and moving about a lens track, such that each of the light beams are temporally focused on a same point in the mist column producing a voxel, a plurality of produced voxels comprising a 3D image.

Various embodiments of the present technology include methods for three-dimensional projection. The methods may comprise: getting air pumped from an air vent and fluid pumped from a fluid reservoir; receiving light from a plurality of light sources; and generating a plurality of mist columns using a plurality of nozzles disposed in an two-dimensional array, each nozzle: atomizing the received air and fluid using an air sheaf comprising air turbine blades and a fluid sheaf comprising fluid turbine blades, projecting the atomized fluid in a mist column using the air sheaf and the fluid sheaf, producing a plurality of light beams using a plurality of lenses and received light, and moving each of the plurality of lenses about a lens track, such that each light beam is temporally focused on a same point in the mist column producing a voxel, a plurality of the produced voxels comprising a 3D image.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments. The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a simplified block diagram of a three-dimensional (3D) projection system according to some embodiments.

FIG. 2 is a simplified block diagram of adaptive control for a 3D projection system in accordance with some embodiments.

FIG. 3A-3C illustrate examples of a 3D projection system according to various embodiments.

FIG. 4 shows a nozzle column, in accordance with various embodiments.

FIG. 5 depicts a nozzle, according to some embodiments.

FIG. 6 is another view of a nozzle column, in accordance with some embodiments.

FIG. 7 another view of a nozzle, according to various embodiments.

FIGS. 8A-8B show a light valve, in accordance with various embodiments.

FIG. 9 is a simplified block diagram of a computing system, according to some embodiments.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Embodiments of the present invention forms a visual representation of an object in three physical dimensions—in contrast to the planar image of traditional screens that simulate depth through a number of different visual effects—without the need for special goggles and/or headgear. Moreover, some embodiments advantageously create imagery without any macroscopic mechanical moving parts in the image volume.

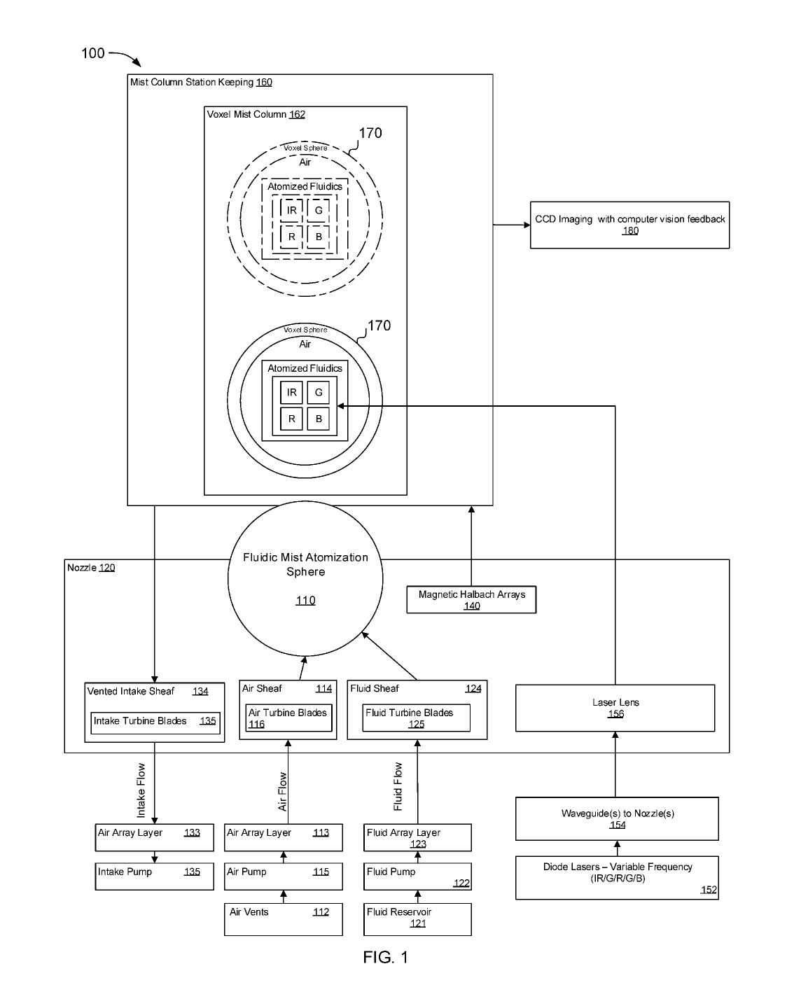

FIG. 1 shows a system 100 for three-dimensional (3D) projection, according to some embodiments. System 100 supports volumetric 3D projection by performing combinations of the following functions: fluid mix atomization, fluid mix pumping, ambient air pumping, voxel column and voxel column array intake pumping, lasing system (e.g., including (four) lasers and (four) waveguides to feed each voxel shaft), power supply, image sensing, input/output (I/O) for at least communication with a computer vision system, and (adaptive) control functions. Fluidic mist atomization sphere 110 at the base of the nozzle mist column is produced by the collision or nozzle action of air from Air Sheaf 114 and fluid from Fluid Sheaf 124. The air is produced using ambient air drawn into system 100 through air vents 111 by air pump 115, and directed through air array layer 113 to a nozzle 120 including air sheaf 114 comprising air turbine blades 116. The fluidic mist may be produced by (concurrently) drawing fluid from fluidic mix reservoir 121 by fluid pump 122, and directing the fluid through fluid array layer 123 to nozzle 120 (further) including fluid sheaf 124 comprising fluid turbine blades 125. Fluidic mist atomization sphere 110 contains many globular fluidic forms of varying volumes whirling around and getting further atomized (broken up) by collisions with pressurized air before they are spun out up into the column where the combined fluid (air and fluidic mist) has a more consistent and more laminar (parallel) flow.

Ambient air drawn into system 100 is air occupying space about system 100. By way of non-limiting example, ambient air contains approximately 78.09% nitrogen, 20.95% oxygen, 0.93% argon, 0.039% carbon dioxide, and small amounts of other gases. Ambient air also contains a variable amount of water vapor, on average around 1% at sea level, and 0.4% over the entire atmosphere.

By way of further non-limiting example, fluid in fluid reservoir 121 is (natural and/or synthetic) glycerol (also known as glycerine or glycerin). Glycerol is a simple polyol (sugar alcohol) compound, colorless, odorless, and a viscous liquid.

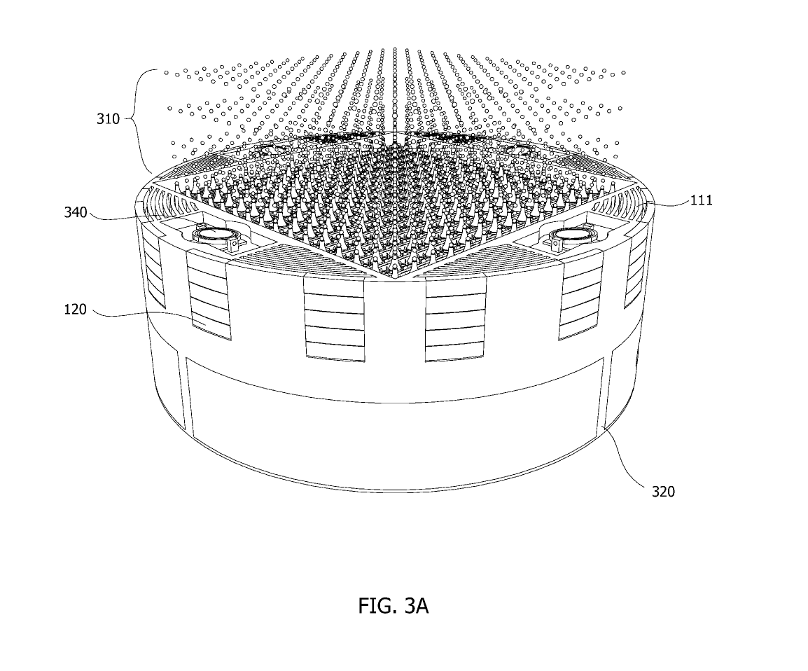

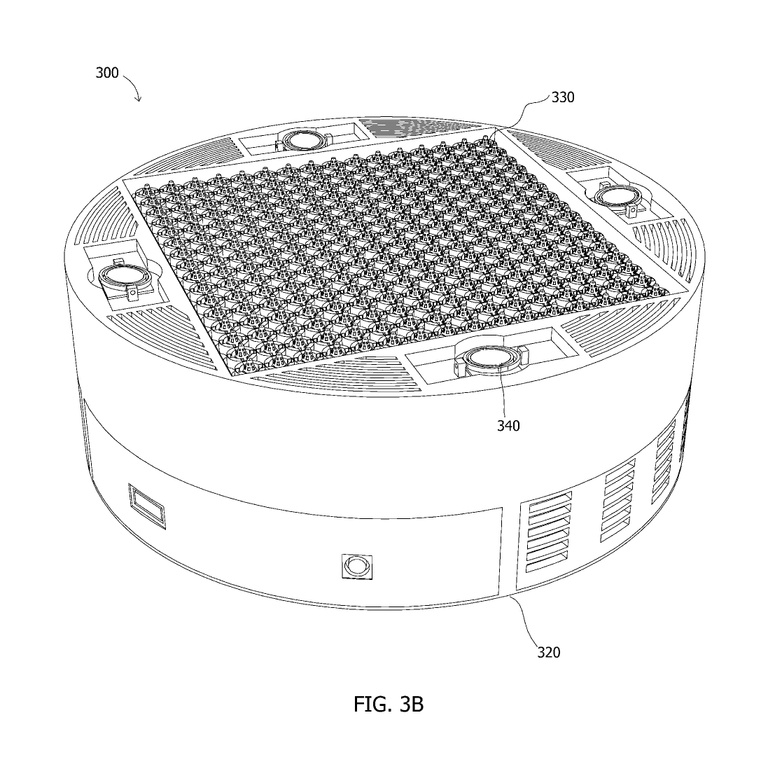

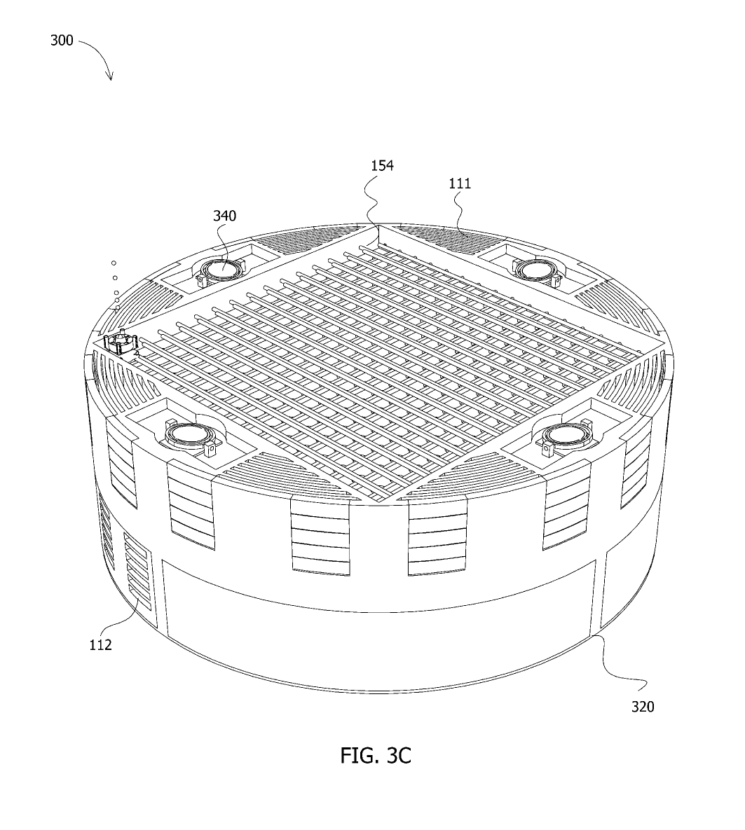

Sodium chloride (e.g., NaCl) may be included in fluid, improving the influence of magnetic field lines (e.g., from magnetic Halbach array 140 and/or magnetic elements 340 (FIGS. 3A-3C)). For example, fluid in fluid reservoir 121 has a sodium chloride concentration ranging from less than 0.1 parts per trillion (10¹²) (ppt) to 50 ppt. In some embodiments, a projection height (e.g., a height of voxel mist column 162) is considered when selecting the sodium chloride concentration. In some embodiments, the sodium chloride concentration is around 34.7 ppt.

Air sheaf 114 and fluid sheaf 124 are each designed such that they included formed air turbine blades 116 and fluid turbine blades 125 (respectively) on at least some of their respective surfaces in contact with air and fluid (respectively). Air and fluid passing through air turbine blades 116 and fluid turbine blades 125 (respectively) are channeled by air turbine blades 116 and fluid turbine blades 125 (respectively), producing a vortex flow sufficient to propagate through mist atomization sphere 110 and into mist column 162 as part of mist column station keeping (process) 160. For example, the fluid atomized and emitted by nozzle 120 is confined to voxel mist column 162.

In addition to fluidic pressure forces generated by nozzle 120 (e.g., air sheaf 114 and fluid sheaf 124), mist column station keeping 140 may be enhanced by magnetic Halbach array 140. Magnetic Halbach array 140 comprises a special arrangement of (permanent) magnets that augment the magnetic field on one side of the array while cancelling the field to near zero on the other side. This can be achieved using a spatially rotating pattern of magnetization. For example, the permanent magnets may be five rare-earth magnets each in substantially the shape of a cylinder, small electromagnets, and the like. By way of further non-limiting example, nozzle 120 includes four Halbach arrays disposed approximately at the corners of a (hypothetical) square around nozzle 120. The Halbach array magnetic field lines produced by magnetic Halbach array 130 contribute to confining the atomized fluid of that nozzle's respective mist column.

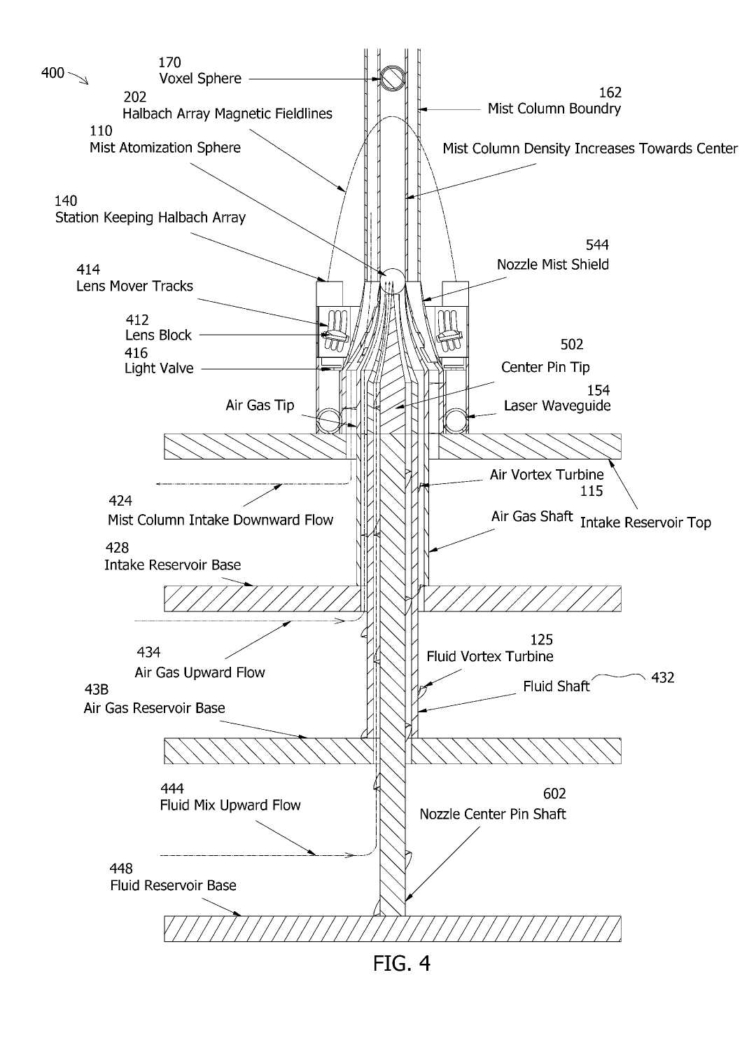

Runoff, emissions, and/or leaks from voxel mist column 162 may be captured using a laminar “reflow” boundary surrounding voxel mist column 162. The laminar reflow includes viscous fluids pulled down by at least the pressure from intake vent sheaf 134 (into intake reservoir 422 shown in FIG. 4). For example, after projection into voxel mist column 162, fluid may be “recycled” (e.g., taken into system 100 and reused) through laminar flow with intake pressure outside and about voxel mist column 162 into intake sheaf 134. Fluid is drawn through vented intake sheaf 134 to intake array layer 133 using intake pump 131 and reused in the fluidic mix reservoir 121. Vented intake sheaf 134 may include intake turbine blades 135. Intake turbine blades 135 may create a vortex which contributes to mist column station keeping 160 (e.g., confines voxel mist column 162).

Voxel mist column 162 provides a medium upon which light may be projected. For example, voxel sphere 170 having a roughly spherical shape is produced when collimated laser light beams focus on a common point in voxel mist column 162. Voxel sphere 170 is colorized by mixing multiple laser lights of different colors or frequency bands. In some embodiments, lasers 152 produce/emit light of different frequencies through a process of optical amplification based on the stimulated emission of electromagnetic radiation. By way of non-limiting example, each nozzle 120 includes four of lasers 152, producing infrared (e.g., roughly having a wavelength of 700 nm (frequency 430 THz) to 1 mm (300 GHz)), red (e.g., roughly having a wavelength of 620 nm (frequency 480 THz) to 740 nm (400 THz)), green (e.g., roughly having a wavelength of 495 nm (frequency 525 THz) to 570 nm (525 THz)), and blue (e.g., roughly having a wavelength of 450 nm (frequency 670 THz) to 495 nm (610 THz)) light. In some embodiments, at least one of lasers 152 is a semiconductor laser, such as a diode laser. Other lasers, such as a photonic-crystal (PhC) laser and/or free-electron laser (FEL), may additionally or alternatively be used.

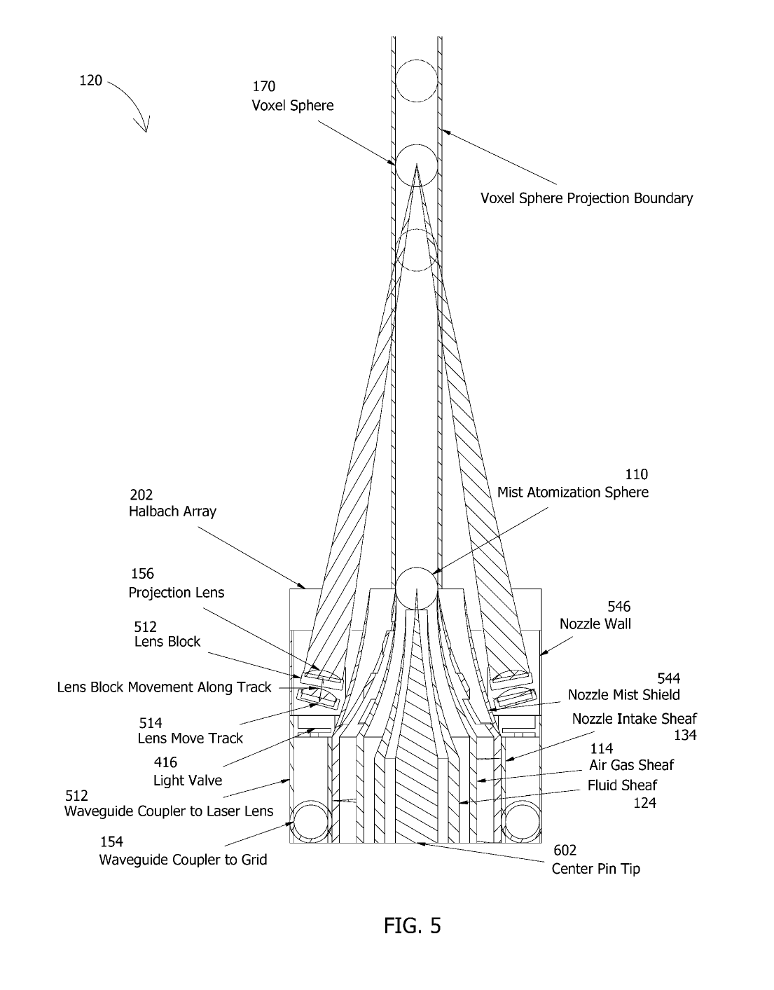

A plurality of waveguides 154 provide light from lasers 152 to a plurality of nozzles 120 (e.g., each nozzle 120 receives light from four waveguides, one waveguide for each color or frequency (band) of light). In some embodiments, wave guide coupler 512 (shown in FIG. 5) changes the angle of the light (e.g., light is guided horizontally to nozzle 120 and then angled “up” to go through lens 156). Waveguides 154 are spatially inhomogeneous structures for guiding light. In some embodiments, waveguides 154 may be crystal or glass materials, such as optical fiber. For example, optical fibers include a transparent core surrounded by a transparent cladding material with a lower index of refraction. Here, light is kept in the core by the phenomenon of total internal reflection which causes the fiber to act as a waveguide.

Lenses 156 are disposed in nozzle 120 and may be fed by a grid/network of waveguides 154 disposed above intake reservoir 422 (shown in FIG. 4). A plurality of lenses 156 (e.g., four lenses) each receive one color or frequency (band) of light, and project the received light onto voxel mist column 142. Each area of voxel mist column 162 receiving the collimated laser light may serve as a voxel, producing mid-air illumination under normal lighting conditions. For example, normal lighting conditions are 20-500 lux. Voxel is a portmanteau for “volume” and “pixel” where pixel is a combination of “picture” and “element.” Voxel sphere 170 results when collimated laser light beams are focused temporally on a common point in voxel mist column 162 forming a voxel of roughly spherical shape. Voxel spheres 170 are each colorized by mixing light of multiple colors or frequency bands (e.g., from lasers 152). Mixing perceived by the viewer's eye is actually adjacent regions of the mist column illuminated by red, green or blue laser sources. Purely for the purposes of analogy, the present light mixing may be thought of as similar to color mixing in a pixel of a color monitor or TV.

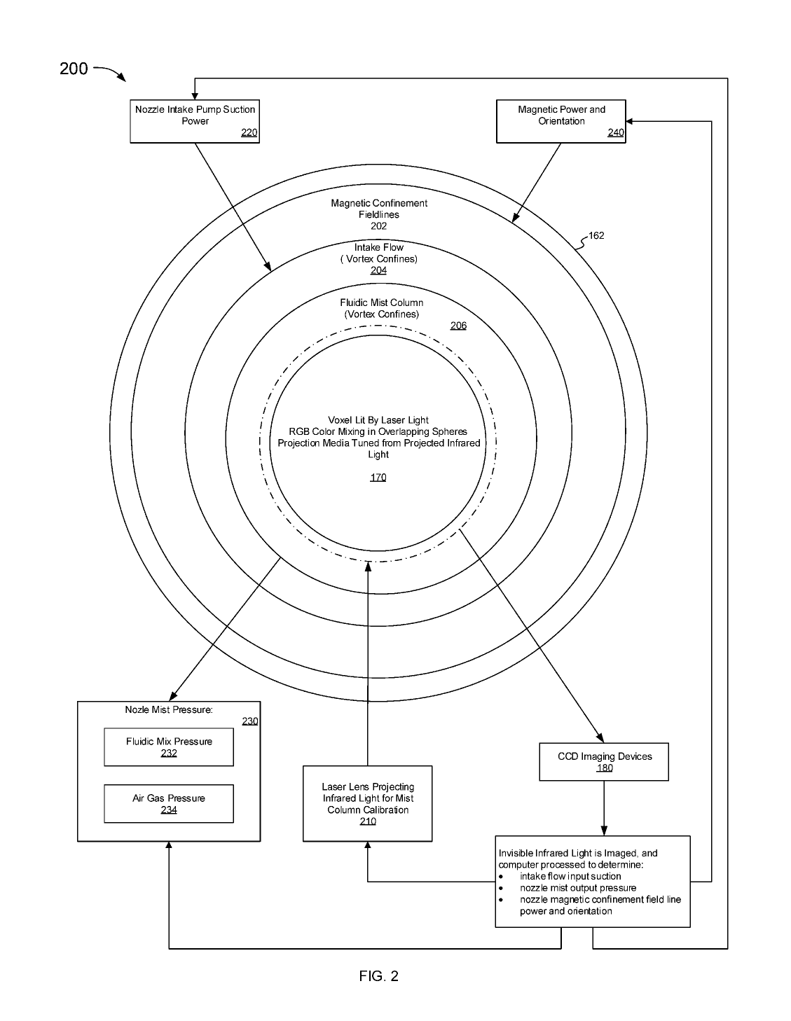

The intensity of light needed to illuminate the area of voxel mist column 162 is advantageously an order of magnitude lower than that needed to illuminate air by itself. Voxel mist column 162 also offers greater stability and illumination factors than air alone. Ambient air is moderately stable being subject to dust particles and voxels would not be visible. Voxel mist column 162 offers greater stability than ambient air, because voxel mist column 162 is confined by a spinning vortex flow produced by turbine blades (e.g., one or more of air turbine blades 116, fluid turbine blades 125, and intake turbine blades 135), has consistent density due to a high degree of atomization, has highly laminar flow (e.g., flows in concentric/parallel layers), and is capable of sustaining adjacent laminar flows (e.g., intake flow 204 (FIG. 2)). Voxels spheres 170 (e.g., in voxel mist column 162) are visible under normal lighting conditions.

Moreover, the laser power necessary for mid-air illumination of regular air (by itself) disadvantageously requires ionization of the air (e.g., turning air into plasma), which can harm the eyes of an (human) observer and produces acoustic effects (e.g., “popping” sound).

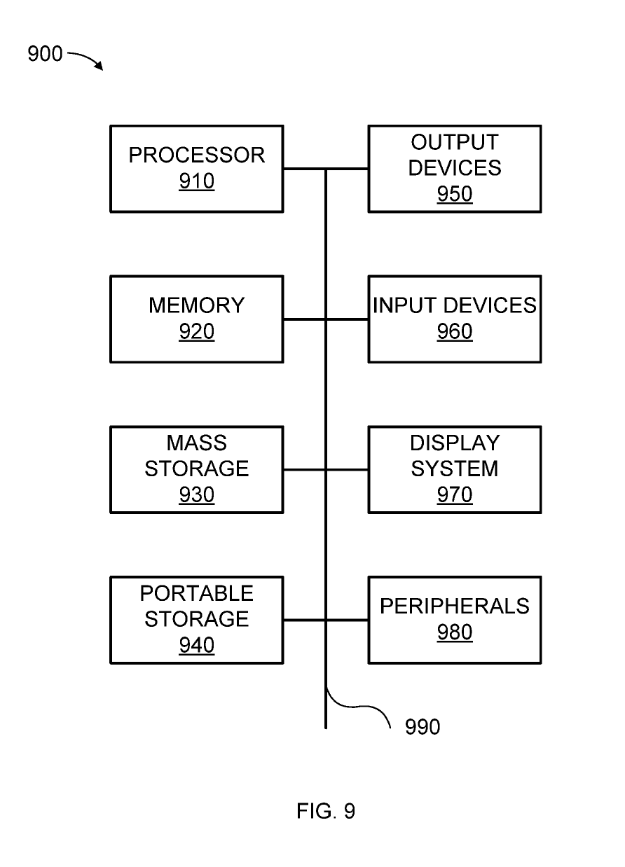

Voxels 170 in voxel mist column 142 may be detected by at least one image sensor 180. In some embodiments, image sensor 180 is a semiconductor charge-coupled device (CCD). Other image sensors, such as an active pixel sensor in complementary metal oxide semiconductor (CMOS) or N-type metal oxide semiconductor (NMOS) technologies, may additionally or alternatively be used. Data from image sensor 180 may be provided to a computer vision system (not shown in FIG. 1) to calibrate and/or adaptively control system 100. The computer vision system may be integrated within or external to system 100. A computer system that may function as the computer vision system is described further in relation to FIG. 9.

FIG. 2 depicts adaptive control 200 of system 100 (FIG. 1), according to some embodiments. Mist column station keeping 160 maintains voxel mist column 162 using combinations of magnetic confinement field 202 (e.g., produced by magnetic Halbach array 140), intake flow vortex 204 (e.g., produced by vented intake sheaf 134), and fluidic mist column vortex 206 (e.g., produced by air sheaf 114 and fluid sheaf 124)). Adaptive control, for example, advantageously compensates for changes to characteristics of voxel mist column 162 caused by, for example, the light heating the fluid.

In various embodiments, voxel sphere 170 is illuminated by infra-red (IR) light 210 (e.g., from one of lasers 152), among others. IR is invisible radiant energy, having electromagnetic radiation with longer wavelengths than those of visible light. Accordingly, IR light is generally not visible to an (human) observer of voxel mist column 162. Image sensor 170 may detect IR light associated with a plurality of voxel spheres 170. The computer vision system using the detected IR light can determine, for example, at least one of intake flow input suction, nozzle mist output pressure, and magnetic confinement field line power and/or orientation associated with one or more nozzles. Based on the determination, adaptive control 200 may adjust intake flow input suction (e.g., by changing the nozzle intake pump suction power 210), nozzle mist output pressure 220 (e.g., by changing fluidic mix pressure 222 and/or air gas pressure 224), and magnetic confinement field line power and/or orientation 230 (e.g., by changing fluidic mix pressure 232 and/or air gas pressure 234) associated with one or more nozzles 120.

In some embodiments, each nozzle 120 at any instant of time may be active (e.g., projecting mist column 162), projecting for station keeping (e.g., projecting intermittently at varying velocities fluid and air from nozzle 120), and dormant (e.g., no projection). For example, nozzle 120 is dormant when corresponding voxel mist column 162 is sufficient to host projection of voxel spheres 170 by IR light 210. Sufficiency can be determined by projecting IR light 210 onto voxel mist column 162 and using IR CCD imaging 180. IR light 210 may be collimated laser light from diode laser 152.

A computer system that may perform at least some operations of adaptive control 200 is described further in relation to FIG. 9. Embodiments of the present invention may include computer systems for control and/or adaptive control that are significantly more than generic computer systems. By way of non-limiting example, a computer system according to some embodiments includes a real-time operating system (RTOS). An RTOS is an operating system (OS) intended to serve real-time application process data as it comes in, typically without buffering delays. Processing time (including any OS delay) may be measured in microsecond (μs) units or shorter. A key characteristic of an RTOS is the level of its consistency concerning the amount of time it takes to accept and complete an application's task; the variability is jitter. RTOSes that may be used include Linux with the PREEMPT_RT patch (also known as the -rt patch or RT patch), Linux with the real-time application interface (RTAI), Linux with the Xenomai real-time development framework, etc.; NetBSD (e.g., with kernel preemption enabled, such as using PREEMPT calls); and microkernels (e.g., L4 microkernel family such as the Open Kernel Labs OKL4, Fiasco.00 microkernel) optionally with L4Linux providing a layer on top for compatibility with pre-existing APIs. Embedded systems (e.g., single-board computers) supporting direct calls to a programmable real-time unit (PRU) using assembly language (e.g., in a single-board computer including one or more programmable real-time unit subsystems (PRUSS) such as a Beaglebone designed by Texas Instruments), and the like may also be used. (Core) Control firmware may comply with real-time speed/performance requirements. Programming languages may include Netwide Assembler (NASM), and other assemblers and disassemblers for a particular microprocessor architecture.

FIGS. 3A-C illustrate system 300, a non-limiting example of system 100 (FIG. 1). System 300 produces a three-dimensional array of voxels in a plurality of voxel mist columns 310. As shown in FIG. 3A, voxel mist columns 310 are disposed in a regular grid and the volume of voxels are disposed in 3D space. When viewing voxel mist columns 310, an (human) observer may perceive an image in three full dimensions. For example, moving the observer's head and eyes does increase information about the 3D objects being displayed. Anything which can be visually perceived in 3D may be included in the image, for example, one or more of an inanimate object and living being. The 3D object represented may be at rest and/or in motion.

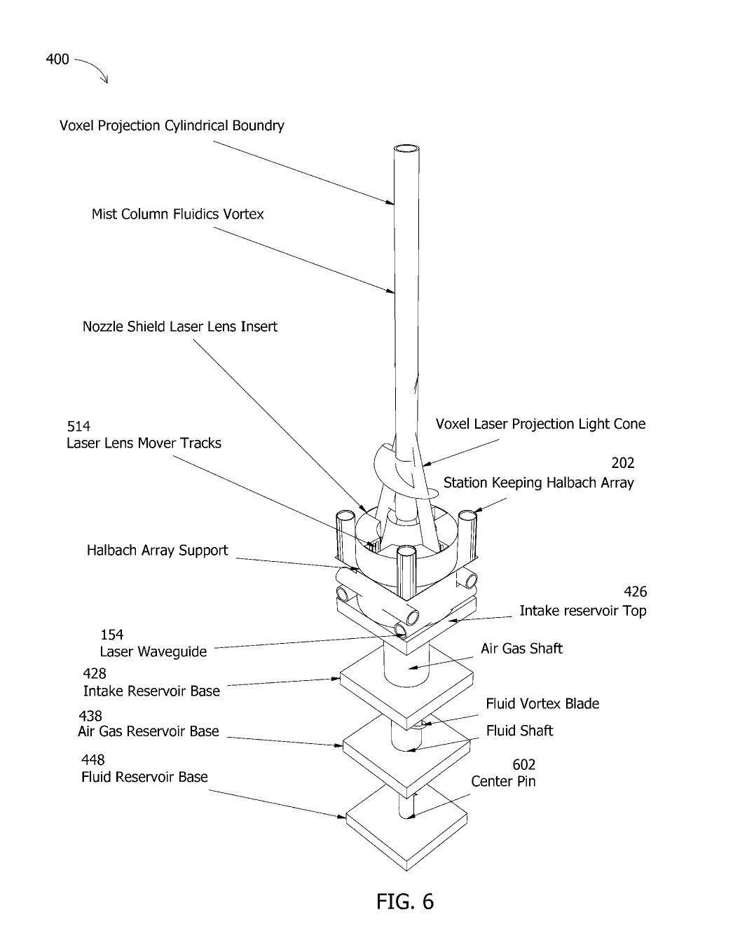

System 300 includes chassis 320. Chassis 320 includes array 330 of nozzles 120, one or more air vents 111, one or more fluidic mix reservoirs 121, and one or more magnetic elements 340 (e.g., disposed in and around air vents 111). Array 330 is comprised of a plurality of nozzle columns 400. In some embodiments, the plurality of nozzle columns 400 are evenly distributed in array 330 (e.g., each nozzle is equidistant from adjacent nozzles). Each nozzle column produces a respective one of voxel mist column 310. Nozzle column 400 is described further in relation to FIGS. 4 and 6.

Each voxel mist column of voxel mist columns 310 may have a corresponding voxel mist column along a z-axis (e.g., where the plurality of nozzle columns 400 in array stack 300 are arranged in an x-y axis plane). The density of the voxel mist column 310 may not limit the time (or temporal) resolution of a 3D projected image. For example, some embodiments are arranged such that multiple two-dimensional arrays are tilted (e.g., arranged a slight angle to an observer) and light projected such that the plurality of voxel mist columns are interlaced.

As described in relation to FIG. 1, air vents 112 take in air from outside of chassis 320 to feed the airpump. Air vents 111 capture emissions (e.g., fluid) outside of the overall projection (e.g., volume of nozzle mist columns) limiting hazy mist from the overall projection. As shown in FIG. 3C, a network of laser waveguides 154 is disposed in chassis 320 and arranged to guide light from lasers 152 to each nozzle column 400 in array 330. Fluidic mix reservoir 121 holds fluid.

Magnetic elements 340 can be (miniature) stacks of Halback arrays disposed in and around vents 111. Halbach arrays were described in relation to FIG. 1. Magnetic elements may produce directional force to circulate emissions (e.g., fluid) outside of the overall projection (e.g., volume of nozzle mist columns) to air vents 111. Chassis 320 may include further components, such as one or more of a fluid mix atomizer, fluid mix pump, ambient air pump, voxel column and voxel column array intake pump, lasers 152, computer system, and power supply, as described in relation to FIG. 1.

Chassis 320 may range in size from roughly 5 mm-100 mm in diameter. For example, chassis 320 having a diameter on the order of 8 mm is installed in an assembly or robot (e.g., chassis 320 is mated/screwed into a mobile robot platform including motors for movement, sensors, and optionally output features). By way of further non-limiting example, chassis 320 having a diameter of approximately 30 mm is included in a smart watch or other wearable computing device. By way of another non-limiting example, chassis 320 having a diameter of about 72 mm provides 3D projection up to approximately 200 mm. Although a generally cylindrical shape is depicted in FIGS. 3A-3C, other shapes may be used. For example, a multi-surface shape from which projections are angled and positioned to project an interlaced (higher resolution) image may be used. By way of further non-limiting example, curved shapes may be used where a plurality of chassis 320 are arranged in an array (e.g., the array having a ring, dish, or spherical shape).

FIG. 4 shows representative nozzle column 400 (which includes nozzle 120) of array 330 and FIG. 5 illustrates nozzle 120, according to some embodiments. Nozzle 120 includes lens block 412. Lens block 412 directs light received from laser waveguide 154 to voxel sphere 170. Lens block 412 includes a lens (e.g., which focuses light produced by lasers 152 onto voxel sphere 170) and a lens mount. The lens may be micro fluidic, such as semi-solid and/or semi-cured gel. The geometry/shape of micro fluidic lenses may be advantageously changed using, for example, a magnetic field. The lens may be solid, such as a clear, cured gel. Gels are a solid, jelly-like material that can have properties ranging from soft and weak to hard and tough. In some embodiments, the lens comprises a magnetoceptive gel, such as silca doped with magnetic nanoparticles. The lens is physically coupled to a lens mount. The lens mount may be made from a synthetic resin, such as epoxy resin and polyester resin.

Lens block 412 is capable of motion in lens track 414. For example, magnetic servos (not depicted in FIG. 4) disposed toward the top and bottom of lens track 414 move lens block 412 up and down along lens track 414 (e.g., at an angle determined by a design/shape of lens track 414). By way of further non-limiting example, shape memory alloy actuator wire (e.g., Flexinol wire) may also be used to move lens block 412. Shape memory alloy actuator wire can contract like muscles when electrically driven (e.g., generating heat) and may be smaller than solenoids and motors. For micron and nano (N/MEMs) scale devices, electrostatic forces can be employed to actuate lens movement. These forces are used to actuate micro mirror position in Digital Micromirror Devices (DMD) chips and here are used to position and angle the lens via movement along lens track 414.

A plurality of voxel spheres 170 are formed in voxel mist column 162 by rapidly shifting the laser lens angle and position about an axis. In conjunction with light valve 416 laser beams can effectively draw any arrangement of distinct voxel spheres on corresponding mist column 162 which will appear to be displayed simultaneously within the same image frame. In some embodiments, lens block 412 moves in lens track 414 at a rate on the order of 1 KHz-3 KHz to 15 KHz. The frequency at which lens block 412 oscillates may be optimized according to the frequency of a 3D rasterization cycle. For example, the frequency of lens block oscillation is sufficiently fast to “draw” (e.g., illuminate) the full length of voxel mist column 162 within the time period of a 3D rasterization cycle (e.g., a cycle time for rendering a full frame of the 3D image) such that it will appear as a completed vertical line to the viewer. By way of non-limiting example, an image produced by system 100 has a refresh rate on the order of 1 KHz.

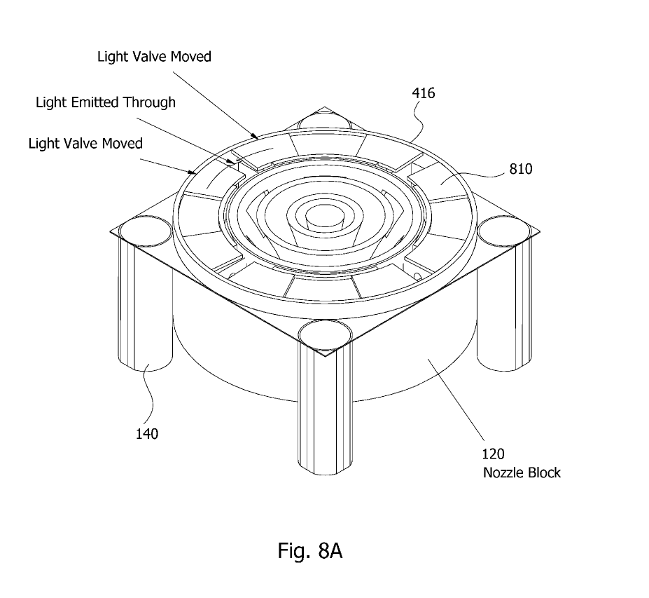

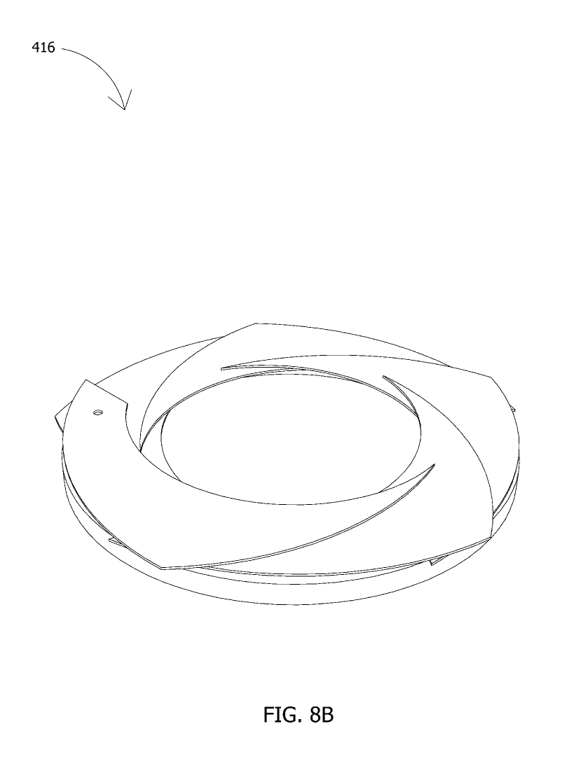

Disposed between lens block 412 and laser waveguide 154 is light valve 416. Light valve 416 controls an amount (intensity) of light received by lens block 412. In some embodiments, light valve 416 includes a shutter 810 that opens and closes (e.g., motion of shutter 810 at least partially covers/obscures lens block 412) using a circular servo, as shown in FIG. 8A. Intensity (maximum valve opening) can also vary when drawing multiple voxels on a column and can partially be a function of visible voxel persistence. Physical dimensions of light valve 416 can be such that light valve 416 blocks lower frequencies of light. For example, a light valve having an aperture less than 622 nm can block red light.

In some embodiments, light valve 416 contributes to dynamic 3D image generation using a (middle) frequency that is a function of the 3D image refresh rate and voxels drawn on the mist column. By way of further non-limiting example, an oscillation frequency of light valve 416 is at least the 3D image refresh rate multiplied by the number of voxels displayed on the mist column such that light emissions by nozzle 120 are switched on and off to visibly render all voxels on a column for the duration of the 3D frame for 3D frame or volumetric frame animation. In various embodiments, light valve 416 tunes and filters artifacts and other deviations in the 3D image (e.g., when an observer/user directly interfaces with the 3D display, such as moving a finger, hand, arm, or other member/object through the 3D projection) using a (high) frequency in the MHz range.

Other designs for light valve 416 may be used. As shown in FIGS. 8B (e.g., open aperture) a hemispherical or iris valve more can accurately control light intensity. At the submicron scale the iris valve may be used alternatively or additionally to filter lower frequencies of light.

As shown in FIG. 4, in some embodiments air vortex turbine 116, fluid vortex 125, and intake turbine vortex 135 each comprise a (different) helical ridge about the air sheaf 114, fluid sheaf 124, and vented intake sheaf 134, respectively. Purely for the purposes of analogy, the helical ridge may be thought of as forming a surface similar (but not necessarily identical) to female threads of a nut into which the male threads of a (matching) screw would mate.

Nozzle column 400 includes intake reservoir 422, air gas reservoir 432, and fluidic mix reservoir 121, disposed under nozzle 120. Intake reservoir 422 holds gas from the mist intake downward flow 424 and is comprised of intake reservoir top 426 and intake reservoir vase 428. Air gas reservoir 432 holds gas received from air vents 112 and is comprised of intake reservoir vase 428 and air gas reservoir base 438. Fluidic mix reservoir 121 holds fluid and is comprised of air gas reservoir base 438 and fluid reservoir base 448.

As depicted in FIGS. 4 and 5, nozzle 120 is wider at one end (e.g., “base”) and narrow at another end (e.g., “tip”). By way of non-limiting example, at approximately the base a diameter of: nozzle shield wall 546 is 1 mm-5 mm (e.g., for an atrium art installation, stage, theater, and auditorium projection, pool table, air hockey table, medical bed (e.g., hospital bed in which a 3D image of a human body is projected for medical purposes or a 3D image is projected to augment an actual human body for surgical purposes), large screen television, and the like), 100 μm-500 μm (e.g., for a hand-held portable computing device to desktop computer monitor/television, and the like), and 10 μm-100 μm (e.g., a wearable computing device such as a smart watch) wide. By way of further non-limiting example, nozzle mist shield 544 is generally 90% of nozzle shield wall 546, 0.9 mm-4.5 mm (e.g., large size), 100 μm-450 μm (e.g., typical size), and 9 μm-90 μm (e.g., small size); fluid sheaf 124 is generally 80% of nozzle shield wall 546, 0.8 mm-4.0 mm (e.g., large size), 100 μm-400 μm (e.g., typical size), and 8 μm-80 μm (e.g., small size); and center pin tip 602 is about 1 mm-50 nm.

By way of further non-limiting example, at substantially the tip a diameter of: nozzle shield wall 546 is generally the same width as at the base or generally 90% of nozzle shield wall 546 (at the tip), 0.5 mm-2.5 mm (e.g., large size), 100 μm-500 μm (e.g., typical size), and 5 μm-50 μm (e.g., small size) in embodiments where the nozzle is warped (e.g., such as when arranged on a curved surface), nozzle mist shield 544 is approximately 25%-75% of nozzle mist shield 544 at the base, fluid sheaf 124 is 25%-75% of fluid sheaf 124 at the base, and center pin tip 602 is generally 25%-75% percent of center pin tip 602 at the base (e.g., on the order of nanometers). Nozzle 120 may be approximately 3 mm-50 mm (e.g., large size), 0.5 mm-3 mm (e.g., typical size), and 0.05 mm-0.5 mm (e.g., small size) long (e.g., distance from distinct features of nozzle 120 to fluid reservoir base 448). Nozzle column 440 may be approximately 15 mm-150 mm (e.g., large size), 10 mm-15 mm (e.g., typical size), and 0.05 mm-0.5 mm (e.g., small size) long. Even at smaller sizes, 3D images at resolutions better than about 400 pixels per inch (PPI) and/or 70 pixels per degree (PPD) may be produced.

FIG. 6 illustrates another view of nozzle column 400, according to various embodiments. Three (of four) magnetic Halbach arrays 140A-140C are shown disposed at positions approximating three corners of a (hypothetical) square. In some embodiments, nozzle column 400 includes four waveguides 154A-154C, for example for guiding IR, red, green, and blue light from lasers 152 (FIG. 1).

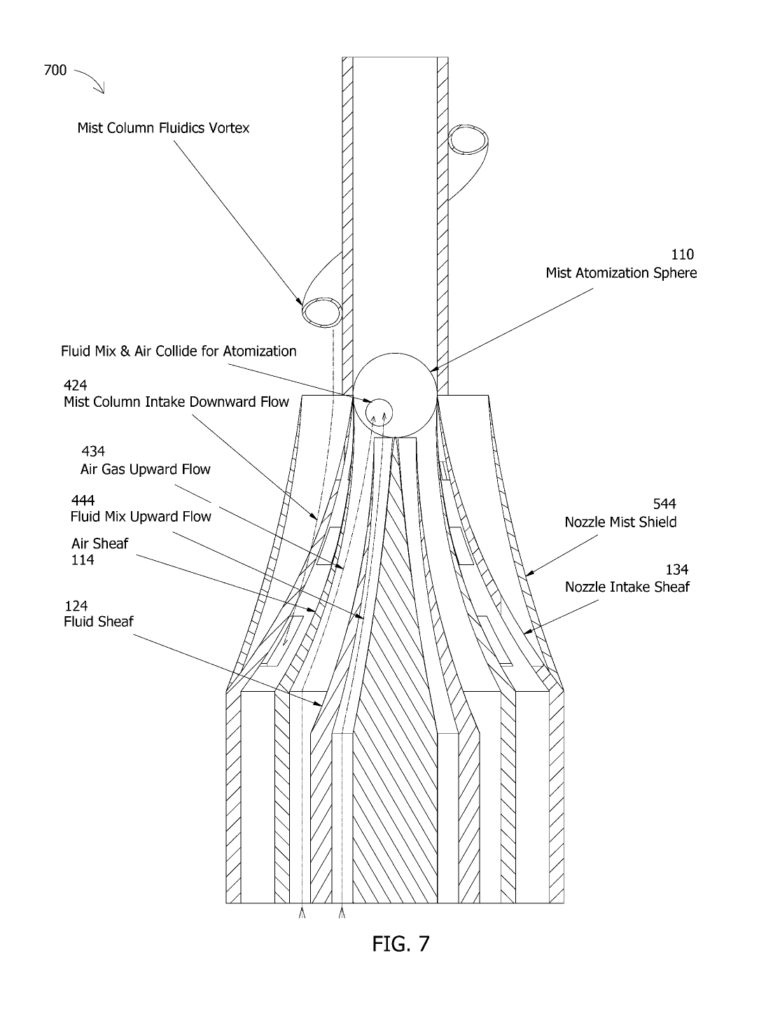

FIG. 7 depicts another view of a top 600 of nozzle 120 according to some embodiments. Fluid mix upward flow 624 runs between an outer surface of center pin 602 and an inner surface of fluid sheaf 124. Air gas upward flow 614 runs between an outer surface of fluid sheaf 124 and an inner surface of air sheaf 114. Mist column downward flow 634 runs between an outer surface of air sheaf 114 and an inner surface of nozzle mist shield 644. An outer surface of nozzle mist shield 644 at least partially blocks mist column intake downward flow 634 from hitting lens block 412.

At least some parts of system 100 as illustrated in FIGS. 1-8B can be made of almost any (eutectic) metal alloy, polymer, and/or ceramic material. By way of non-limiting example, some parts of system 100 are made of at least one of: 17-4 and 15-5 stainless steel, maraging steel, cobalt chromium, inconel 625 and 718, titanium Ti6Al4V, neodymium, thermoplastics (e.g. polylactic acid or polylactide (also known as PLA and PolyPLA), acrylonitrile butadiene styrene (ABS), high-impact polystyrene (HIPS), Nylon, etc.), high-density polyethylene (HDPE) or polyethylene high-density (PEHD), photopolymer, rubber (e.g., sugru), modeling clay, plasticine, room temperature vulcanization (RTV) silicone, porcelain, metal clay (including Precious Metal Clay), metal matrix composite, ceramic matrix composite, and the like.

FIG. 9 illustrates an exemplary computer system 900 that may be used to implement some embodiments of the present invention. The computer system 900 in FIG. 9 may be implemented in the contexts of the likes of computing systems, networks, servers, or combinations thereof. The computer system 900 in FIG. 9 includes one or more processor unit(s) 910 and main memory 920. Main memory 920 stores, in part, instructions and data for execution by processor unit(s) 910. Main memory 920 stores the executable code when in operation, in this example. The computer system 900 in FIG. 9 further includes a mass data storage 930, portable storage device 940, output devices 950, user input devices 960, a graphics display system 970, and peripheral device(s) 980.

The components shown in FIG. 9 are depicted as being connected via a single bus 990. The components may be connected through one or more data transport means. Processor unit(s) 910 and main memory 920 are connected via a local microprocessor bus, and the mass data storage 930, peripheral device(s) 980, portable storage device 940, and graphics display system 970 are connected via one or more input/output (I/O) buses.

Mass data storage 930, which can be implemented with a magnetic disk drive, solid state drive, or an optical disk drive, is a non-volatile storage device for storing data and instructions for use by processor unit(s) 910. Mass data storage 930 stores the system software for implementing embodiments of the present disclosure for purposes of loading that software into main memory 920.

Portable storage device 940 operates in conjunction with a portable non-volatile storage medium, such as a flash drive, floppy disk, compact disk, digital video disc, or Universal Serial Bus (USB) storage device, to input and output data and code to and from the computer system 900 in FIG. 9. The system software for implementing embodiments of the present disclosure is stored on such a portable medium and input to the computer system 900 via the portable storage device 940.

User input devices 960 can provide a portion of a user interface. User input devices 960 may include one or more microphones, an alphanumeric keypad, such as a keyboard, for inputting alphanumeric and other information, or a pointing device, such as a mouse, a trackball, stylus, or cursor direction keys. User input devices 960 can also include a touchscreen and/or a haptic input device. Additionally, the computer system 900 as shown in FIG. 9 includes output devices 950. Suitable output devices 950 include speakers, printers, network interfaces, and monitors.

Graphics display system 970 include a liquid crystal display (LCD), a virtual reality head-mounted display, or other suitable display device. Graphics display system 970 is configurable to receive textual and graphical information and processes the information for output to the display device.

Peripheral device(s) 980 may include any type of computer support device to add additional functionality to the computer system.

The components provided in the computer system 900 in FIG. 9 are those typically found in computer systems that may be suitable for use with embodiments of the present disclosure and are intended to represent a broad category of such computer components that are well known in the art. Thus, the computer system 900 in FIG. 9 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including Linux with the PREEMPT_RT patch (also known as the -rt patch or RT patch), with the real-time application interface (RTAI), with the real-time Xenomai real-time development framework, etc.; NetBSD (e.g., with kernel preemption enabled, such as using PREEMPT calls); and microkernels (e.g., L4 microkernel family such as the Open Kernel Labs OKL4, Fiasco.00 microkernel) with pertinent application programming interfaces (APIs) on top via 141inux.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 900 may be implemented as a cloud-based computing environment, such as a virtual machine operating within a computing cloud. In other embodiments, the computing system 900 may itself include a cloud-based computing environment, where the functionalities of the computing system 900 are executed in a distributed fashion. Thus, the computing system 900, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 900, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical, magnetic, and solid-state disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages and APIs. For example, the GNU compiler collection (GCC) and Netwide Assembler (NASM) may be used. By way of further non-limiting example, APIs for multi-core graphics processor units (GPUs) (e.g., Compute Unified Device Architecture (CUDA) by NVIDIA Corporation, Open Source Computer Vision (OpenCV), etc.), for parallel computing (e.g., Open Multi-Processing (OpenMP), Open Computing Language (OpenCL), etc.), and the like may be used. Other programming languages and/or APIs optimized for real-time computer graphics and positioning of physical real-world fluids in 3D space may additionally or alternatively be used. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

What is claimed is:

1. A three-dimensional (3D) projection system comprising:
an air pump receiving air from an air vent and providing the air to a plurality of nozzles;
a fluid pump receiving fluid from a fluid reservoir and providing the fluid to the plurality of nozzles;
a plurality of light sources providing a light to the plurality of nozzles; and
the plurality of nozzles disposed in an evenly-spaced two-dimensional array, each nozzle including:
an air sheaf receiving the pumped air and comprising air turbine blades,
a fluid sheaf receiving the pumped fluid and comprising fluid turbine blades,
then each nozzle atomizing the fluid with the air and projecting the atomized fluid in a mist column using the air sheaf and the fluid sheaf, and
a plurality of lenses each producing a light beam using light generated by a respective one of the plurality of light sources and moving about a lens track, such that each of the light beams is temporally focused on a same point in the mist column producing a voxel, a plurality of produced voxels comprising a 3D image.

2. The 3D projection system of claim 1 wherein the plurality of light sources produce at least one of infrared light, red light, green light, and blue light.

3. The 3D projection system of claim 2 wherein the plurality of light sources are each a diode laser.

4. The 3D projection system of claim 3 wherein the fluid includes glycerin and sodium chloride.

5. The 3D projection system of claim 1 further comprising:
a charge-coupled device (CCD) sensor receiving light from the 3D image and providing first data associated with the 3D image to a computer vision system; and
a control system receiving second data from the computer vision system and using the second data to change at least one of an output pressure of at least one nozzle, a magnetic confinement field line power, and intake flow input suction.

6. The 3D projection system of claim 1 further comprising:
a plurality of waveguides each coupling a respective one of the plurality of light sources to at least one of the plurality of nozzles.

7. The 3D projection system of claim 6 wherein each of the plurality of nozzles further comprises:
a plurality of light valves, each light valve controlling an intensity of the light received from a respective one of the plurality of waveguides.

8. The 3D projection system of claim 7 wherein the plurality of lenses are gel lenses.

9. The 3D projection system of claim 1 wherein each of the plurality of nozzles further comprises:
four magnetic Halbach arrays disposed around a diameter of the mist column, the Halbach arrays contributing to a station keeping of the mist column.

10. The 3D projection system of claim 1 wherein each of the plurality of nozzles further comprises:
a vented intake sheaf receiving emissions from the mist column for recycling.

11. A method for three-dimensional (3D) projection comprising:
getting air pumped from an air vent and fluid pumped from a fluid reservoir;
receiving light from a plurality of light sources; and
generating a plurality of mist columns using a plurality of nozzles disposed in an two-dimensional array, each nozzle:
atomizing the received air and fluid using an air sheaf comprising air turbine blades and a fluid sheaf comprising fluid turbine blades,
projecting the atomized fluid in a mist column using the air sheaf and the fluid sheaf,
producing a plurality of light beams using a plurality of lenses and received light, and
moving each of the plurality of lenses about a lens track, such that each light beams are temporally focused on a same point in the mist column producing a voxel, a plurality of the produced voxels comprising a 3D image.

12. The 3D projection method of claim 11 wherein the received light is at least one of infrared light, red light, green light, and blue light.

13. The 3D projection method of claim 12 wherein the received light is from at least one diode lasers.

14. The 3D projection method of claim 13 wherein the fluid includes glycerin and sodium chloride.

15. The 3D projection method of claim 1 further comprising:
receiving light from the 3D image using a charge-coupled device (CCD) sensor;
creating first data associated with the 3D image using the CCD sensor;
providing the first data to a computer vision system;
receiving second data from the computer vision system; and
changing at least one of an output pressure of at least one nozzle, a magnetic confinement field line power, and intake flow input suction using the second data.

16. The 3D projection method of claim 11 further comprising:
coupling one of the plurality of light sources to at least one of the plurality of nozzles using a waveguide.

17. The 3D projection method of claim 16 wherein the generating further comprises:
controlling an intensity of the light received from the waveguide using a light valve.

18. The 3D projection method of claim 17 wherein the plurality of lenses are gel lenses.

19. The 3D projection method of claim 11 wherein the generating further comprises:
enhancing a station keeping of the mist column using four magnetic Halbach arrays disposed around a diameter of the mist column.

20. The 3D projection method of claim 11 further comprising:
recycling emissions from at least one mist column using a vented intake sheaf.
